(19) United States
(12) Patent Application Publication
(10) Pub. No.: US 2012/0279796 A1
(43) Pub. Date: Nov. 8, 2012

(54) PASSIVE RADIATOR

(75) Inventors: YOU-RUEI LIN, New Taipei (TW); Sheng-shan Chen, New Taipei (TW)

(73) Assignee: Cheng Uei Precision Industry Co., LTD., New Taipei City (TW)

(21) Appl. No.: 13/102,989

(22) Filed: May 6, 2011

(51) Int. Cl. H04R 7/00

(52) U.S. Cl. 181/148

(57) ABSTRACT

A passive radiator comprises a frame body having an opening; a diaphragm disposed on the frame body and located corresponding to the opening; and a surround which joins with an outer margin of the diaphragm; wherein the diaphragm is extended from a radial position to a center position to form a recess cavity, and the recess cavity has a replaceable weighting unit disposed therein. The passive radiator can improve bass tone performance for audio products.

### TECHNICAL FIELD OF THE INVENTION

The present invention relates to a passive radiator, and more particularly, to a passive radiator used in a loudspeaker.

### BACKGROUND OF THE INVENTION

Generally, a loudspeaker utilizes vibrating a diaphragm to produce an acoustic sound. Mainly, the loudspeaker utilizes a repulsive interaction, which is resulted from a magnet interacting with a voice coil having an electrical current passed by, to move the diaphragm in the front of the magnet in a back and forth motion. The acoustic sound is generated accordingly and radiated out from a center.

A passive radiator, also called a drone, is a part of the loudspeaker without the voice coil and the magnet. Because the passive radiator does not carrier electricity to radiate the acoustic sound, it is referred to as a drone.

FIG. 1 is a cutaway view of a traditional loudspeaker. As shown in FIG. 1, the traditional loudspeaker 10 includes a frame body 12, a magnet 14, a magnetic conductive plate 142, a magnetic conductive yoke 143, a voice coil 16, a thin diaphragm 18, and a surround 19. The thin diaphragm 18 is disposed corresponding to an opening formed on the frame body 12. The surround 19 is disposed around the margin of the thin diaphragm 18. The traditional loudspeaker 10 utilizes a pressure wave 101, which is resulted by an induction between the voice coil 16 and a magnetic field formed by the magnet 14, the plate 142, and the yoke 143, to move the thin diaphragm 18 in a back and forth motion to generate a sound wave.

FIG. 2 is a cutaway view of a conventional passive radiator. As shown in FIG. 2, the conventional passive radiator 20 is a part of a loudspeaker without a voice coil and a magnet. The conventional passive radiator 20 has a weighting member 17 disposed below a thin diaphragm 18. The weighting member 17 is utilized for improving the sound performance. However, the conventional passive radiator 20 is a standardized product and may not satisfy a user's demands to adjust audio performance by the user.

The traditional loudspeaker has certain physical properties which limit a bass tone performance to be adequate, such as a smaller size of a sound box and a smaller area of a diaphragm. Although some audio products can achieve an excellent bass sound effect, a user is not able to adjust the audio performance. Therefore, improving the bass sound effect, especially for the audio products of small sizes, and providing a function which allows a user to adjust the audio performance are important aspects for the industry.

### SUMMARY OF THE INVENTION

An objective of the present invention is to provide a passive radiator for solving a problem of lacking bass sounds in audio products.

Another objective of the present invention is to provide a passive radiator for a user to adjust an audio performance by the user.

To achieve the above objectives, the present invention provides a passive radiator, which comprises a frame body having an opening; a diaphragm disposed on the frame body and located corresponding to the opening; and a surround which joins with an outer margin of the diaphragm; wherein the diaphragm is extended from a radial position to a center position to form a recess cavity, and the recess cavity has a replaceable weighting unit disposed therein.

Since the replaceable weighting unit is equipped in the present invention, the passive radiator of the present invention can lead to an excellent bass tone performance when the passive radiator is assembled with a voice coil and a magnet unit to form a loudspeaker. Moreover, for the same bass tone performance, the present invention can reduce the size of a sound box, which may be required for an original structure to be a larger size. Furthermore, the present invention can satisfy various users for different demands on bass sound effects.

### BRIEF DESCRIPTION OF THE DRAWINGS

The present invention will be described in details in conjunction with the appending drawings.

FIG. 1 is a cutaway view of a traditional loudspeaker.

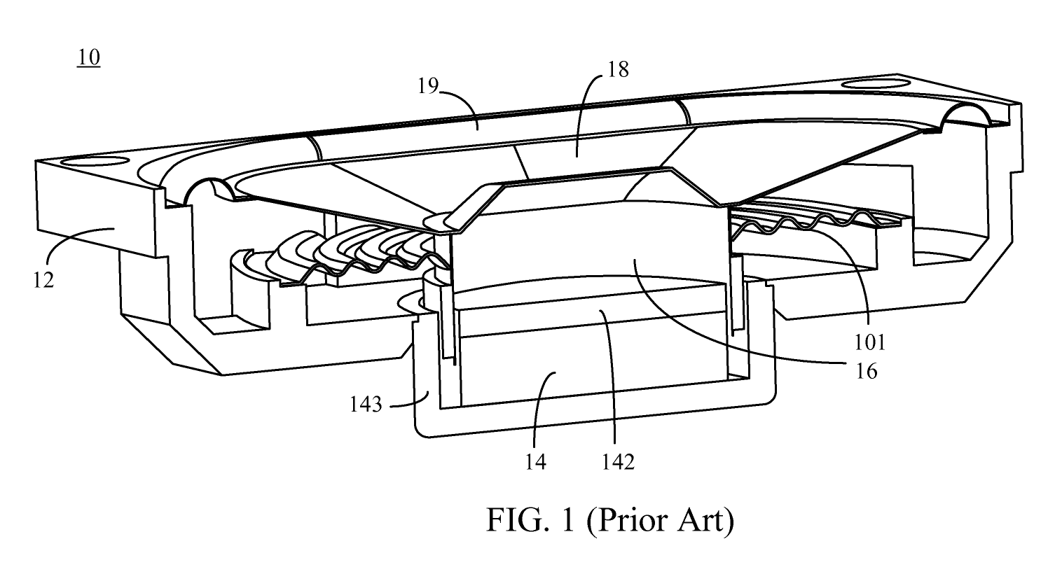

FIG. 2 is a cutaway view of a conventional passive radiator.

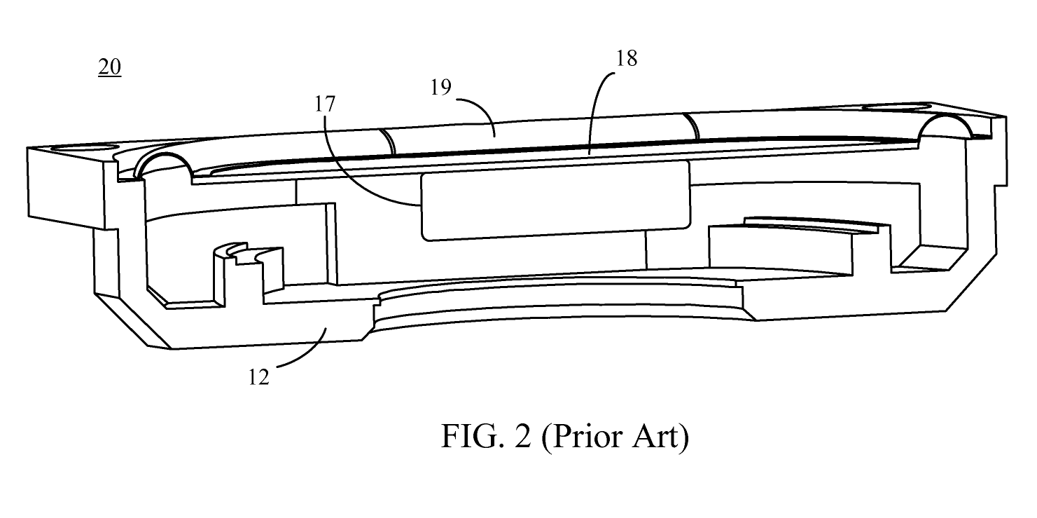

FIG. 3 is a cutaway view of a passive radiator according to a first embodiment of the present invention.

FIG. 4 is a cutaway view of a passive radiator according to a second embodiment of the present invention.

### DETAILED DESCRIPTION OF THE INVENTION

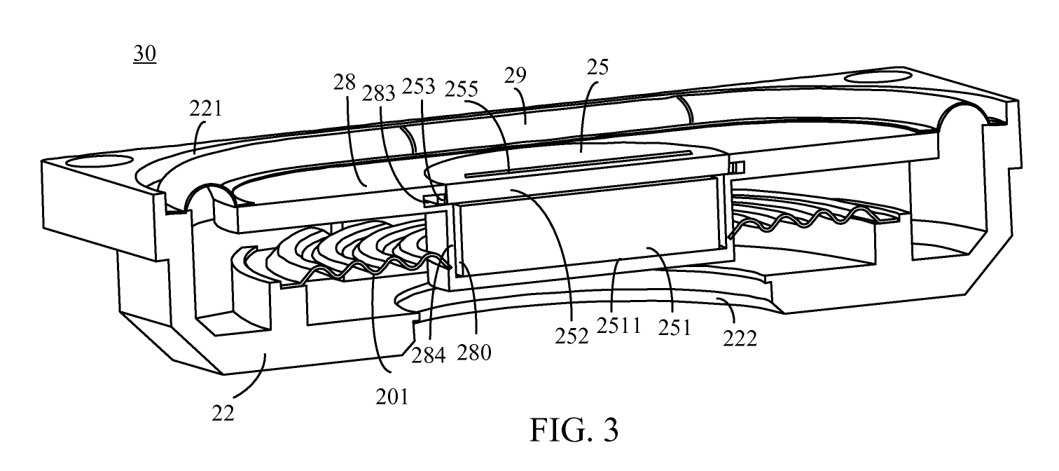

FIG. 3 is a cutaway view of a passive radiator according to a first embodiment of the present invention. As shown in FIG. 3, the passive radiator 30 of the first embodiment of the present invention includes a frame body 22, a diaphragm 28, a surround 29, and a replaceable weighting unit 25 disposed on the diaphragm 28. The frame body 22 is a structural object having certain strength and the frame body 22 serves as a frame or a bracket to connect the diaphragm 28 and the surround 29. The frame body 22 has a first opening 221 formed on one side and a second opening 222 formed on an opposite side thereto. The diaphragm 28 is disposed on the frame body 22 and located corresponding to the first opening 221. The size and shape of the diaphragm 28 are basically identical to those of the first opening 221. The diaphragm 28 is utilized to produce an acoustic sound by vibration. The surround 29 can be made of an elastic material possessing recovery properties, for example, a fabric, a PU rubber, and polyester foam. The surround 29 is utilized for joining an outer margin of the diaphragm 28. In addition, the second opening 222 of the frame body 22 is provided for assembling a voice coil (not shown) and a magnet unit (not shown). The passive radiator 30 is inherently formed without the voice coil and the magnet unit.

The passive radiator 30 of the present invention is an audio device without an electro-magnetic field system and does not transduce between electrical energy and magnetic energy. Generally speaking, an electrical signal from an audio player is amplified by a power amplifier and then the amplified signal is sent to drive a loudspeaker. The passive radiator 30 is adopt for producing a sound wave by obeying a physical law, that is, the slower the vibrating speed, the lower the sound frequency. In the present invention, the replaceable weighting unit 25 is utilized for adjusting the lower frequencies of sound wave.

The replaceable weighting unit 25 is disposed in a recess cavity 280. The recess cavity 280 is formed by extending the diaphragm 28 from a radial position to a center position. As shown in FIG. 3, in a place corresponding to the second opening 222 of the frame body 22, the diaphragm 28 extends downwardly to form a U-shaped recess cavity 280. The weighting unit 25 and the recess cavity 280 substantially have the same shape. In the embodiment of FIG. 3, the weighting unit 25 and the recess cavity 280 are a cylinder shape, but it is not limited to. The weighting unit 25 and the recess cavity 280 also can be a cone shape or other shapes.

The weighting unit 25 can affect the tension of the diaphragm 28 and such structure can lead to an excellent bass tone performance for a loudspeaker. Moreover, the weighting unit 25 is designed to be replaceable so that a user can replace with different mass elements as desired to achieve various degrees of bass tone.

Referring to FIG. 3, the weighting unit 25 includes a mass element 251 and a lid 252. The lid 252 covers a surface of the mass element 251. The lid is used to fix the mass element 251 so as not to be separated from the frame body 22 or fall apart when the passive radiator 30 is moved around. Moreover, the lid 252 is designed to be able to press the mass element 251 so as to contact the diaphragm 28 tighter. The mass element 251 of the weighting unit 25 has a bottom surface attached to the diaphragm 28. The weighting unit 25 substantially occupies all accommodating spaces of the recess cavity 280 formed by the diaphragm 28. In such manner, the weighting unit 25 can affect more effectively the tension of the diaphragm 28. Furthermore, the diaphragm 28 of the present invention can be implemented by a high-strength uneasily-deformed structure instead of a structure of a low-strength easily-deformed film such as a paper, a thin-film plastic, and a thin-film fabric. The high-strength uneasily-deformed diaphragm can make the bass tone performance better.

The recess cavity 280 formed by the diaphragm 28 has a wall 284 disposed with a fastening mechanism, such as a fastening socket 283. The lid 252 of the weighting unit 25 has a protrusion 253 on the side. The protrusion 253 of the lid 252 is engaged with the fastening socket 283. In such manner, the weighting unit 25 is fixed to the diaphragm 28 and assembled with the diaphragm 28 together. The present invention is not limited to the fastening manner of the protrusion 253 and the fastening socket 283. Other mechanisms for fixing the lid 252 to the diaphragm 28 may include, for example, compression fitting, dovetail connection, and interlocking mechanism.

The lid 252 of the weighting unit 25 has an upper surface disposed with a slot 255. The slot 255 is used for conveniently removing the lid 252 or assembling the lid 252 by applying a force. When a user intends to replace the mass element 251 with another element of different weights, the user can apply a force to the slot 255 to rotate the lid 252 such that the protrusion 253 of the lid 252 is departed from the fastening socket 283 on the wall 284 of the recess cavity 280, and thereby removing the lid 252 and being able to replace the mass element 251. After the mass element 251 is replaced with another mass element, the user may also apply a force to the slot 255 to rotate the lid 252 such that the protrusion 253 of the lid 252 is engaged with the fastening socket 283, and thereby fixing the lid 252.

According to acoustic physical law, the overall audio performance will be much rich when the frequency of a sound wave is lower and possessed more intense to certain level. The passive radiator of the present invention acts in a supporting role to produce the sound wave and can achieve an excellent bass tone performance when the passive radiator is assembled to form a loudspeaker. The present invention can solve a problem of lacking bass sounds in conventional audio products. Moreover, for the same bass tone performance, the present invention can reduce the size of a sound box, which may be required for an original structure to be a larger size. Furthermore, the weighting unit of the passive radiator of the present invention is designed to be replaceable. A user can adjust the sound performance by himself, and therefore the present invention can satisfy a user's demands on bass tone effects.

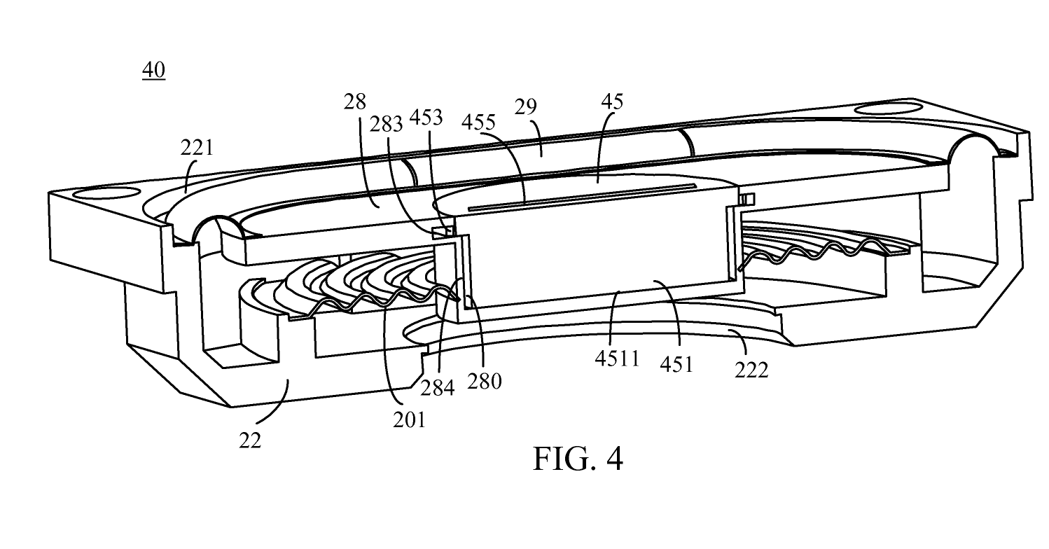

FIG. 4 is a cutaway view of a passive radiator according to a second embodiment of the present invention. The difference between the first embodiment and the second embodiment is that the weighting unit of the passive radiator of the second embodiment is an integrally-formed structure combining the lid and the mass element. As shown in FIG. 4, the weighting unit 45 of the passive radiator 40 includes a mass element 451 having a protrusion 453. The mass element 451 has a bottom surface 4511 attached to an inner surface of the recess cavity 280 which is formed by extending the diaphragm 28. The recess cavity 280 has a wall 284 disposed with a fastening socket 283, and the protrusion 453 of the mass element 451 is engaged with the fastening socket 283. In addition, the mass element 451 of the weighting unit 45 has an upper surface disposed with a slot 455. The slot 455 is used for conveniently removing the mass element 451 or assembling the mass element 451 by applying a force. In the second embodiment of the present invention, the weighting unit of the passive radiator is integrally formed and thereby having an advantage of structure integrity. The second embodiment can avoid a detrimental effect caused by collisions between the lid and the mass element as compared to the first embodiment.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A passive radiator, comprising:
a frame body having an opening;
a diaphragm disposed on the frame body and located corresponding to the opening; and
a surround which joins with an outer margin of the diaphragm;
wherein the diaphragm is extended from a radial position to a center position to form a recess cavity, and the recess cavity has a replaceable weighting unit disposed therein.

2. The passive radiator according to claim 1, wherein the weighting unit comprises a mass element.

3. The passive radiator according to claim 2, wherein the mass element has a bottom surface attached to the diaphragm.

4. The passive radiator according to claim 2, wherein the weighting unit further comprises a lid covering the mass element.

5. The passive radiator according to claim 4, wherein the recess cavity formed by the diaphragm has a wall disposed with a fastening mechanism, and the lid of the weighting unit is fixed to the fastening mechanism.

6. The passive radiator according to claim 4, wherein the lid of the weighting unit has a slot being used for conveniently removing the lid by applying a force.

7. The passive radiator according to claim 1, wherein the weighting unit comprises a mass element having a protrusion.

8. The passive radiator according to claim 7, wherein the recess cavity formed by the diaphragm has a wall disposed with a fastening socket, and the protrusion of the mass element is engaged with the fastening socket.

9. The passive radiator according to claim 1, wherein the weighting unit substantially occupies all accommodating spaces of the recess cavity.

10. The passive radiator according to claim 1, wherein the weighting unit and the recess cavity substantially have the same shape.
